(19) United States
(12) Patent Application Publication
(10) Pub. No.: US 2025/0293793 A1
(43) Pub. Date: Sep. 18, 2025

(54) METHOD AND APPARATUS FOR HARQ-ACK ENHANCEMENT

(71) Applicant: LENOVO (BEIJING) LIMITED, Beijing (CN)

(72) Inventors: Haipeng Lei, Beijing (CN); Yu Zhang, Beijing (CN); Ruixiang Ma, Beijing (CN); Haiming Wang, Beijing (CN)

(21) Appl. No.: 18/860,951

(22) PCT Filed: Apr. 29, 2022
(86) PCT No.: PCT/CN2022/090551

§ 371 Date: Oct. 28, 2024

(51) Int. Cl. H04L 1/00; H04L 5/00; H04W 72/23

(52) U.S. Cl. CPC H04L 1/0003; H04L 5/0055; H04W 72/23

(57) ABSTRACT

Embodiments of the present disclosure relate to methods and apparatuses for HARQ-ACK enhancement. According to some embodiments of the disclosure, a UE may: receive, from a BS, a set of DCI formats for scheduling a set of PDSCHs on a first set of carriers, wherein the set of DCI formats indicates the same slot for the UE to transmit HARQ-ACK feedback for the set of PDSCHs; generate MCS adjustment feedback comprising MCS adjustment information for each of the first set of carriers; and transmit, to the BS, the MCS adjustment feedback in the slot.

### TECHNICAL FIELD

Embodiments of the present disclosure generally relate to wireless communication technology, and more particularly to hybrid automatic repeat request acknowledgement (HARQ-ACK) enhancement.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In a wireless communication system, a user equipment (UE) may monitor a physical downlink control channel (PDCCH) in one or more search spaces. The PDCCH may carry downlink control information (DCI), which may schedule uplink channels, such as a physical uplink shared channel (PUSCH), or downlink channels, such as a physical downlink shared channel (PDSCH). A UE may transmit HARQ-ACK feedback (e.g., included in a HARQ-ACK codebook) corresponding to PDSCH transmissions through a physical uplink control channel (PUCCH) or a physical uplink shared channel (PUSCH).

It would be beneficial if a UE can provide a BS, besides HARQ-ACK feedback, additional information such as interference fluctuation information or modulation and coding scheme (MCS) adjustment information. Such additional information would, for example, reduce transmission delay and improve spectrum efficiency. The industry desires technologies for facilitating HARQ-ACK enhancement in a communication system.

### SUMMARY

Some embodiments of the present disclosure provide a user equipment (UE). The UE may include a transceiver, and a processor coupled to the transceiver. The processor may be configured to: receive, from a base station (BS), a set of downlink control information (DCI) formats for scheduling a set of physical downlink shared channels (PDSCHs) on a first set of carriers, wherein the set of DCI formats indicates the same slot for the UE to transmit hybrid automatic repeat request acknowledgement (HARQ-ACK) feedback for the set of PDSCHs; generate modulation and coding scheme (MCS) adjustment feedback comprising MCS adjustment information for each of the first set of carriers; and transmit, to the BS, the MCS adjustment feedback in the slot.

In some embodiments of the present disclosure, the MCS adjustment information for each carrier of the first set of carriers indicates a first MCS offset value from a first set of MCS offset values for a corresponding carrier in the case that a PDSCH of the set of PDSCHs received on the corresponding carrier is correctly decoded by the UE. In some embodiments of the present disclosure, the MCS adjustment information for each carrier of the first set of carriers indicates a second MCS offset value from a second set of MCS offset values for the corresponding carrier in the case that the PDSCH received on the corresponding carrier is incorrectly decoded by the UE. In some embodiments of the present disclosure, the number of values in the first set of MCS offset values is the same as that in the second set of MCS offset values. In some embodiments of the present disclosure, a size of the MCS adjustment information for the corresponding carrier is based on a larger set of the first set of MCS offset values and the second set of MCS offset values.

In some embodiments of the present disclosure, for a first PDSCH of the set of PDSCHs received on a first carrier of the first set of carriers, the HARQ-ACK feedback for the first PDSCH is not transmitted in the slot.

Some embodiments of the present disclosure provide a base station (BS). The BS may include a transceiver, and a processor coupled to the transceiver. The processor may be configured to: transmit, to a user equipment (UE), a set of downlink control information (DCI) formats for scheduling a set of physical downlink shared channels (PDSCHs) on a first set of carriers, wherein the set of DCI formats indicates a same slot for the UE to transmit hybrid automatic repeat request acknowledgement (HARQ-ACK) feedback for the set of PDSCHs; and receive, from the UE, modulation and coding scheme (MCS) adjustment feedback in the slot, wherein the MCS adjustment feedback comprises MCS adjustment information for each of the first set of carriers.

In some embodiments of the present disclosure, the processor may be configured to receive the HARQ-ACK feedback for the set of PDSCHs along with the MCS adjustment feedback in the slot.

In some embodiments of the present disclosure, the processor may be configured to adjust an MCS of a subsequent transmission to the UE on the first set of carriers based on the MCS adjustment feedback.

Some embodiments of the present disclosure provide a method for wireless communication performed by a UE. The method may include: receiving, from a base station (BS), a set of downlink control information (DCI) formats for scheduling a set of physical downlink shared channels (PDSCHs) on a first set of carriers, wherein the set of DCI formats indicates the same slot for the UE to transmit hybrid automatic repeat request acknowledgement (HARQ-ACK) feedback for the set of PDSCHs; generating modulation and coding scheme (MCS) adjustment feedback comprising MCS adjustment information for each of the first set of carriers; and transmitting, to the BS, the MCS adjustment feedback in the slot.

Some embodiments of the present disclosure provide a method for wireless communication performed by a BS. The method may include: transmitting, to a user equipment (UE), a set of downlink control information (DCI) formats for scheduling a set of physical downlink shared channels (PDSCHs) on a first set of carriers, wherein the set of DCI formats indicates a same slot for the UE to transmit hybrid automatic repeat request acknowledgement (HARQ-ACK) feedback for the set of PDSCHs; and receiving, from the UE, modulation and coding scheme (MCS) adjustment feedback in the slot, wherein the MCS adjustment feedback comprises MCS adjustment information for each of the first set of carriers.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIGS. 2 and 3 illustrate a flow chart of an exemplary procedure of wireless communications in accordance with some embodiments of the present disclosure; and

FIG. 4 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

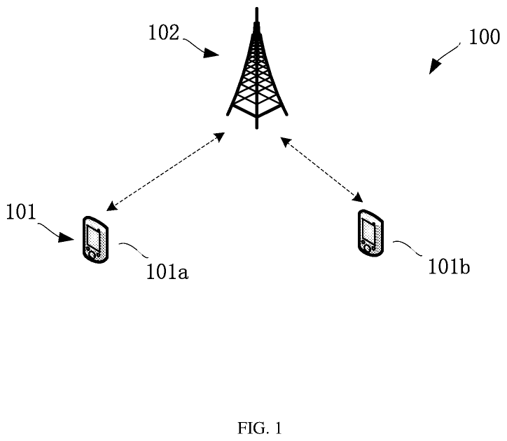

FIG. 1 illustrates a schematic diagram of a wireless communication system 100 in accordance with some embodiments of the present disclosure.

As shown in FIG. 1, wireless communication system 100 may include some UEs 101 (e.g., UE 101a and UE 101b) and a base station (e.g., BS 102). Although a specific number of UEs 101 and BS 102 are depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with the BS 102 via uplink (UL) communication signals.

The BS 102 may be distributed over a geographic region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BSs 102. The BS 102 may communicate with UE(s) 101 via downlink (DL) communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in some other embodiments, the BS 102 and UE(s) 101 may communicate over unlicensed spectrums. The present disclosure is not intended to be limited to the implementation of any particular wireless communication system architecture or protocol.

In some embodiments of the present disclosure, a wireless communication system may support transport block (TB)-based (re)transmission and code block group (CBG)-based (re)transmission.

For TB-based (re)transmission, one HARQ-ACK feedback bit may correspond to one TB for indicating whether the TB is correctly decoded or not. For example, a negative acknowledgement (NACK) may be reported as long as one code block (CB) of a TB is not correctly decoded at the receiver (e.g., a UE) side. Otherwise, if the TB is correctly decoded, an acknowledgement (ACK) may be reported.

For CBG-based (re)transmission, one HARQ-ACK feedback bit may correspond to one CBG of a TB for indicating whether the CBG of the TB is correctly decoded or not. For example, when all the code blocks within one CBG are correctly decoded, the HARQ-ACK feedback for the CBG can be set to an ACK; otherwise, it is set to “NACK”.

Certain traffic in a communication system may have a tight delay budget constraint. Many use cases may also require high throughput. Moreover, the traffic model is bursty. This combination of requirements and scenarios presents a challenge for link adaptation. For example, extended reality (XR) traffic has a variable data packet size and a stringent delay budget. For example, sometimes the XR traffic is generated with a larger data packet size, and sometimes with a small data packet size. In many use cases of XR, high throughput and low latency transmission are both required; otherwise, user experience would be worse.

One thing relevant to throughput is interference estimation and MCS selection, which is very challenging to application scenarios such as XR, since bursty interference from neighboring cells may be fluctuated and unpredictable due to traffic fluctuation and beamforming changing in the neighboring cells. Furthermore, considering delays in channel state information (CSI) reporting, link adaptation for such application scenarios (e.g., XR) may be not accurately sufficient such that a selected MCS cannot be an optimal one. When the selected MCS for a downlink transmission (e.g., PDSCH) is underestimated, spectrum utilization efficiency may be reduced. When the selected MCS for a downlink transmission (e.g., PDSCH) is overestimated, an incorrect decoding may occur and a BS may have to retransmit the downlink transmission (e.g., PDSCH), which leads to not only a transmission delay but also to low spectrum efficiency.

It would be beneficial if a UE could provide a BS, in addition to the HARQ-ACK feedback, additional information such as interference fluctuation information or MCS adjustment information. Such additional information would be very helpful for the BS to select a better MCS to adapt traffic fluctuation and burst interference so that not only the transmission delay is reduced but also the spectrum efficiency is improved. Both benefits are quite important to, for example, XR traffic.

Embodiments of the present disclosure provide solutions for HARQ-ACK enhancement. These solutions can reduce transmission delay and improve spectrum efficiency. For example, addition information such as MCS feedback information may be provided in addition to HARQ-ACK feedback. More details on the embodiments of the present disclosure will be illustrated in the following text in combination with the appended drawings.

In some embodiments of the present disclosure, a new HARQ-ACK feedback mode may be supported. A BS may transmit RRC signaling to a UE to configure such HARQ-ACK feedback mode. As will be described in the following embodiments in detail, under such mode, a UE may provide MCS adjustment feedback information to a BS in addition to HARQ-ACK feedback information.

In some embodiments of the present disclosure, a UE may receive a plurality of PDSCHs on a plurality of carriers (for example, in the carrier aggregation (CA) case, the UE may be configured with a number of carriers including the plurality of carriers). Each PDSCH may carry a corresponding TB. The HARQ-ACK feedback for the plurality of PDSCHs is to be multiplexed in one HARQ-ACK codebook. For example, a plurality of DCI formats scheduling the plurality of PDSCHs may indicate the same resource (e.g., the same slot) for transmitting the HARQ-ACK feedback.

The HARQ-ACK codebook may include: HARQ-ACK feedback (e.g., HARQ-ACK information bits) for the plurality of PDSCHs (e.g., plurality of TBs) (denoted as a first part) and MCS adjustment feedback (denoted as a second part). The HARQ-ACK feedback (e.g., HARQ-ACK information bits) may be generated according to the HARQ-ACK codebook type (e.g., Type 1, Type 2, or Type 3 HARQ-ACK codebook as specified in 3GPP specifications) and indicate whether the plurality of PDSCHs (e.g., the plurality of TBs) are correctly decoded or not. The BS can know the decoding status of the plurality of PDSCHs (e.g., plurality of TBs) based on the first part.

The MCS adjustment feedback may include carrier-specific MCS adjustment information, for example, MCS adjustment information with respect to a reference MCS index for each of the plurality of carriers or for each of the configured carriers. In some embodiments, the MCS adjustment information for the plurality of carriers or for the configured carriers may be ordered according to a predetermined or predefined rule. For example, the MCS adjustment information for the plurality of carriers or for the configured carriers may be ordered in the second part according to the serving cell indexes associated with the plurality of carriers or the configured carriers.

In some embodiments, the MCS adjustment information may indicate an MCS offset value for a corresponding carrier from a set of MCS offset values. For example, the MCS adjustment information may indicate to increase or decrease the reference MCS index with the indicated offset value for the corresponding carrier. In some examples, the indicated offset value may be equal to “0” which indicates keeping the reference MCS index unchanged.

In some embodiments, for each of the plurality of carriers or for each of the configured carriers, a corresponding set of MCS offset values may be configured by, for example, RRC signaling, or predefined. In some embodiments, same or different sets of MCS offset values may be configured for the plurality of carriers or the configured carriers. The number of bits for indicating an MCS offset value (e.g., by indicating the index of the value) from a corresponding set of MCS offset values for a corresponding carrier may be based on the number of values in the corresponding set of MCS offset values. For example, MCS offset value set {+1, 0, −1, −2} may be shared among all the configured carriers. At least two bits may be required in the second part for each of the plurality of carriers or for each of the configured carriers to indicate a specific MCS offset value.

In some embodiments, the number of bits in the second part (e.g., the size of the MCS adjustment feedback) may be determined based on the number of all configured carriers and the number of values in the set of MCS offset values for each of the configured carriers. For example, assuming that M carriers are configured for the UE and N₁. N₂, . . . , N_{M} values are configured within the respective sets of MCS offset values for M configured carriers, then the second part may include at least Z1=┌log₂ N₁┐+┌log₂ N₂┐+ . . . +┌log₂ N_{M}┐ bits for indicating the carrier-specific MCS adjustment information.

In the above embodiments, the second part may include MCS adjustment information for a carrier (denoted as carrier #A1) which is configured for the UE but does not belong to the plurality of carriers where at least one of the plurality of PDSCHs is received and scheduled by at least one of the plurality of DCI formats.

In some examples, a padding bit(s) may be generated in the second part for carrier #A1. The number of the padding bits may be based on the number of values in a set of MCS offset values for carrier #A1. A BS may ignore the carrier-specific MCS adjustment information for carrier #A1.

In some examples, the MCS adjustment information for carrier #A1 may be indicated with reference to a reference MCS index for a reference carrier. Various methods may be employed to determine the reference carrier. For example, the reference carrier may be a carrier nearest to carrier #A1 in the frequency domain among the plurality of carriers where at least one of the plurality of PDSCHs is received. For example, the reference carrier may be a carrier with a serving cell index closest to that of carrier #A1 among the plurality of carriers where at least one of the plurality of PDSCHs is received and the serving cell index of the reference carrier may be larger or smaller than the serving index of carrier #A1. For example, the reference carrier may be a carrier with the lowest or highest serving cell index among the plurality of carriers where at least one of the plurality of PDSCHs is received.

In some embodiments, the number of bits in the second part (e.g., the size of the MCS adjustment feedback) may be determined based on the number of the plurality of carriers (e.g., where at least one PDSCH (e.g., TB) of the plurality of PDSCHs is received and scheduled by a DCI format(s) of the plurality of DCI formats) and the number of values in the set of MCS offset values for each of the plurality of carriers. For example, assuming that the plurality of PDSCHs is received on Y carriers and P₁, P₂, . . . , P_{Y} values configured within the respective sets of MCS offset values for the Y carriers, then the second part may include at least Z2=total ┌log₂ P₁┐+┌log₂ P₂┐+ . . . +┌log₂ P_{Y}┐ bits for indicating the carrier-specific MCS adjustment information. In these embodiments, the second part may not include MCS adjustment information for carrier #A1.

Various methods may be employed to determine a reference MCS index for a carrier. For example, the following methods can be used to determine the reference MCS index for the reference carrier and the reference MCS index for each of the plurality of carriers.

In some embodiments, the reference MCS index for a carrier (denoted as carrier #B1) may indicate an MCS of a specific PDSCH of at least one PDSCH of the plurality of PDSCHs received on carrier #B1. For example, among the plurality of PDSCHs received on the plurality of carries, a set of PDSCHs may be received on carrier #B1, and the DCI formats scheduling the set of PDSCHs may indicate the respective MCSs of the set of PDSCHs. The reference MCS index for carrier #B1 may indicate the MCS of the last or earliest received PDSCH among the set of PDSCHs.

In some embodiments, the reference MCS index for carrier #B1 may indicate an average MCS of the set of PDSCHs received on carrier #B1. For example, based on the MCSs of the set of PDSCHs indicated by the DCI formats, an average MCS index can be determined. In some examples, the average MCS may correspond to an MCS index within an MCS table nearest to the average value of the MCS indices for the set of PDSCHs received on carrier #B1.

The MCS adjustment information for carrier #B1 may be determined based on whether the reference MCS index for carrier #B1 is underestimated, appropriate, or overestimated.

In the case that the reference MCS index for carrier #B1 is underestimated or conservative, the MCS adjustment information for carrier #B1 may indicate a positive MCS offset value from the set of MCS offset values for carrier #B1. For example, the UE may measure that the current interference level on carrier #B1 is lower than the last CSI reporting, and may determine that the reference MCS index is underestimated. The UE may thus determine that a higher MCS index with respect to the reference MCS index can be used in a subsequent (re)transmission on carrier #B1. The BS may use a higher MCS index with respect to the reference MCS index for a subsequent (re)transmission on carrier #B1.

In the case that the reference MCS index for carrier #B1 is appropriate, the MCS adjustment information for carrier #B1 may indicate no change (e.g., an MCS offset value of “0” from the set of MCS offset values for carrier #B1). For example, the UE may measure that the current interference level on carrier #B1 is not changed compared to the last CSI reporting, and may determine that the reference MCS index is appropriate. The UE may thus determine that an MCS index equal to the reference MCS index can be used in a subsequent (re)transmission on carrier #B1. The BS may use the same MCS index with respect to the reference MCS index for a subsequent (re)transmission on carrier #B1.

In the case that the reference MCS index for carrier #B1 is overestimated or aggressive, the MCS adjustment information for carrier #B1 may indicate a negative MCS offset value from the set of MCS offset values for carrier #B1. For example, the UE may measure that the current interference level on carrier #B1 is higher than the last CSI reporting, and may determine that the reference MCS index is overestimated. The UE may thus determine that a lower MCS index with respect to the reference MCS index can be used in a subsequent (re)transmission on carrier #B1. The BS may use a lower MCS index with respect to the reference MCS index for a subsequent (re)transmission on carrier #B1.

Assuming that a reference MCS index for carrier #B1 is n1 and the MCS adjustment information for carrier #B1 is x1, this implies that the UE considers that an MCS with an index of n1+x1 on carrier #B1 is more appropriate for a subsequent (re)transmission to the UE. At the BS side, in response to the reception of the MCS adjustment information for carrier #B1, the BS can adjust the MCS for subsequent (re)transmission to the UE on carrier #B1 with reference to the reference MCS index for carrier #B1.

For example, it is assumed that that a UE is configured with three carriers (e.g., carriers #1-#3) and receives three DCI formats scheduling three PDSCHs on two carriers (e.g., PDSCHs #1 and #2 on carrier #1 and PDSCH #3 on carrier #2), and the three DCI formats indicate respective MCSs for the three PDSCHs and the same slot for transmitting HARQ-ACK feedback for PDSCHs #1, #2 and #3. For example, HARQ-ACK feedback for PDSCHs #1, #2 and #3 may be multiplexed in a HARQ-ACK codebook to be transmitted on the indicated resource. The HARQ-ACK codebook may include a first part including HARQ-ACK feedback for PDSCHs #1, #2 and #3 (e.g., ACK or NACK) and a second part including MCS adjustment information.

The UE may determine a reference MCS index for carrier #1 (e.g., reference MCS index #1) based on the MCS of one of PDSCH #1 and PDSCH #2 as indicated in the corresponding DCI format or an average MCS for carrier #1. The UE may determine a reference MCS index for carrier #2 (e.g., reference MCS index #2) corresponding to the MCS of PDSCH #3 indicated in the DCI format scheduling PDSCH #3. The UE may separately determine whether reference MCS index #1 and reference MCS index #2 are underestimated, appropriate, or overestimated. Assuming that the UE determines reference MCS index #1 being underestimated and reference MCS index #2 being appropriate, and carriers #1-#3 share the same MCS offset value set {+1, 0, −1, −2}, the MCS adjustment information for carrier #1 may indicate the value “+1” from the MCS offset value set and the MCS adjustment information for carrier #2 may indicate the value “0” from the MCS offset value set.

In some embodiments, the second part of the HARQ-ACK codebook may only include the MCS adjustment information for carrier #1 and the MCS adjustment information for carrier #2.

In some embodiments, the second part of the HARQ-ACK codebook may additionally include MCS adjustment information for carrier #3. In some examples, the MCS adjustment information for carrier #3 may include a padding bit(s) (e.g., at least two bits for the MCS offset value set {+1, 0, −1, −2}). In some examples, the MCS adjustment information for carrier #3 may be in reference to a reference MCS index for a reference carrier. For example, assuming that the UE determines that the reference carrier is carrier #2 according to aforementioned method (e.g., the UE determines that the reference carrier is carrier #2 since carrier #2 is the nearest carrier to carrier #3 compared with carrier #1 in the frequency domain), the UE may determine the MCS adjustment information for carrier #3 with respect to reference MCS index #2. For example, the UE may measure whether the current interference level on carrier #3 is lower than, equal to, or higher than the last CSI reporting for carrier #2, and may determine, based on the measurement, that the reference MCS index (e.g., reference MCS index #2) is underestimated, appropriate, or overestimated, which may respectively correspond to a positive MCS offset value, a zero MCS offset value, or a negative MCS offset value in the MCS adjustment information for carrier #3.

In some embodiments of the present disclosure, a UE may receive a plurality of PDSCHs on a single carrier, and the HARQ-ACK feedback for the plurality of PDSCHs is to be multiplexed in one HARQ-ACK codebook. Each PDSCH may carry a corresponding TB. For example, a plurality of DCI formats may schedule the plurality of PDSCHs on the same carrier (denoted as carrier #B2) and may indicate the same resource (e.g., the same slot) for transmitting the HARQ-ACK feedback for the plurality of PDSCHs.

The HARQ-ACK codebook may include: HARQ-ACK feedback (e.g., HARQ-ACK information bits) for the plurality of PDSCHs (e.g., plurality of TBs) (denoted as a first part) and MCS adjustment feedback (denoted as a second part). The HARQ-ACK feedback (e.g., HARQ-ACK information bits) may be generated according to the HARQ-ACK codebook type (e.g., Type 1, Type 2, or Type 3 HARQ-ACK codebook as specified in 3GPP specifications) and indicate whether the plurality of PDSCHs (e.g., the plurality of TBs) are correctly decoded or not. The BS can know the decoding status of the plurality of PDSCHs (e.g., plurality of TBs) based on the first part.

The MCS adjustment feedback may include MCS adjustment information for carrier #B2, for example, MCS adjustment information with respect to a reference MCS index for carrier #B2. In some embodiments, the MCS adjustment information may indicate an MCS offset value from a set of MCS offset values for carrier #B2. For example, the MCS adjustment information may indicate to increase or decrease the reference MCS index with the indicated offset value for carrier #B2. In some examples, the indicated offset value may be equal to “0” which indicates keeping the reference MCS index unchanged.

The set of MCS offset values for carrier #B2 may be configured by, for example, RRC signaling, or predefined. The number of bits for indicating an MCS offset value (e.g., by indicating the index of the value) from the set of MCS offset values for carrier #B2 may be based on the number of values in the set of MCS offset values for carrier #B2. For example, assuming that N values are configured in the set of MCS offset values for carrier #B2, then the second part (e.g., the size of the MCS adjustment feedback) may include at least Z3=┌log₂ N┐ bits for indicating the MCS adjustment information for carrier #B2. For instance, MCS offset value set {+1, 0, −1, −2} may be configured for carrier #B2. At least two bits may be required in the second part for carrier #B2 to indicate a specific MCS offset value from the MCS offset value set.

Various methods may be employed to determine a reference MCS index for carrier #B2.

In some embodiments, the reference MCS index for carrier #B2 may indicate an MCS of a specific PDSCH of the plurality of PDSCHs received on carrier #B2. For example, the plurality of DCI formats scheduling the plurality of PDSCHs may indicate the respective MCSs of the plurality of PDSCHs. The reference MCS index for carrier #B2 may indicate the MCS of the last or earliest received PDSCH among the plurality of PDSCHs.

In some embodiments, the reference MCS index for carrier #B2 may indicate an average MCS of the plurality of PDSCHs received on carrier #B2. For example, based on the MCSs of the plurality of PDSCHs indicated by the plurality of DCI formats, an average MCS index can be determined. In some examples, the average MCS may correspond to an MCS index within an MCS table nearest to the average value of the MCS indices for the plurality of PDSCHs received on carrier #B2.

The MCS adjustment information for carrier #B2 may be determined based on whether the reference MCS index for carrier #B2 is underestimated, appropriate, or overestimated.

In the case that the reference MCS index for carrier #B2 is underestimated or conservative, the MCS adjustment information for carrier #B2 may indicate a positive MCS offset value from the set of MCS offset values for carrier #B2. For example, the UE may measure that the current interference level on carrier #B2 is lower than the last CSI reporting, and may determine that the reference MCS index is underestimated. The UE may thus determine that a higher MCS index with respect to the reference MCS index can be used in a subsequent (re)transmission on carrier #B2. The BS may use a higher MCS index with respect to the reference MCS index for a subsequent (re)transmission on carrier #B2.

In the case that the reference MCS index for carrier #B2 is appropriate, the MCS adjustment information for carrier #B2 may indicate no change (e.g., an MCS offset value of “0” from the set of MCS offset values for carrier #B2). For example, the UE may measure that the current interference level on carrier #B2 is not changed compared to the last CSI reporting, and may determine that the reference MCS index is appropriate. The UE may thus determine that an MCS index equal to the reference MCS index can be used in a subsequent (re)transmission on carrier #B2. The BS may use the same MCS index with respect to the reference MCS index for a subsequent (re)transmission on carrier #B2.

In the case that the reference MCS index for carrier #B2 is overestimated or aggressive, the MCS adjustment information for carrier #B2 may indicate a negative MCS offset value from the set of MCS offset values for carrier #B2. For example, the UE may measure that the current interference level on carrier #B2 is higher than the last CSI reporting, and may determine that the reference MCS index is overestimated. The UE may thus determine that a lower MCS index with respect to the reference MCS index can be used in a subsequent (re)transmission on carrier #B2. The BS may use a lower MCS index with respect to the reference MCS index for subsequent (re)transmission on carrier #B2.

Assuming that a reference MCS index for carrier #B2 is n2 and the MCS adjustment information for carrier #B2 is x2, this implies that the UE considers that an MCS with an index of n2+x2 on carrier #B2 is more appropriate for a subsequent (re)transmission to the UE. At the BS side, in response to the reception of the MCS adjustment information for carrier #B2, the BS can adjust the MCS for subsequent (re)transmission to the UE on carrier #B2 with reference to the reference MCS index for carrier #B2.

In some embodiments of the present disclosure, a UE may receive a PDSCH on a carrier, and the UE may transmit both HARQ-ACK feedback for the PDSCH (e.g., a TB carried by the PDSCH) and MCS adjustment feedback, which may include MCS adjustment information for the current MCS used for transmitting the PDSCH (e.g., the TB). The current MCS for transmitting the PDSCH may be indicated in the DCI format scheduling the PDSCH. The HARQ-ACK feedback (e.g., HARQ-ACK information bits) for the PDSCH (e.g., the TB) may be an ACK or NACK indicating whether the PDSCH (e.g., the TB) is correctly decoded or not. The BS can know the decoding status of the PDSCH (e.g., the TB) based on the HARQ-ACK feedback.

The MCS adjustment information may indicate to increase or decrease the current MCS index (e.g., corresponding to the MCS for transmitting the PDSCH as indicated in the DCI format) with an offset value. In some examples, the offset value may be equal to “0” which indicates keeping the current MCS index unchanged.

For example, two sets of MCS offset values for indicating an MCS adjustment can be configured by, for example, RRC signaling, or predefined. One set (denoted as set #A1) may be applied when the PDSCH (e.g., the TB) is correctly decoded (e.g., an ACK is reported). Another set (denoted as set #A2) may be applied when the PDSCH (e.g., the TB) is incorrectly decoded (e.g., a NACK is reported). The MCS adjustment information may indicate an MCS offset value from set #A1 or set #A2 depending on the decoding status of the PDSCH (e.g., the TB).

The number of bits (denoted as Z4) for indicating an MCS offset value (e.g., by indicating the index of the value) from set #A1 or set #A2 may be based on the number of values in set #A1 and set #A2. In some examples, the two sets may include the same number (e.g., Q) of values so that there is only one size for the MCS adjustment information (e.g., Z4=at least ┌log₂ Q┐ bits). In some examples, the two sets may include different numbers of values. For example, assuming that set #A1 may include Q1 values and set #A2 may include Q2 values, the size of the MCS adjustment information may be based on the larger one of Q1 and Q2. For example, Z4=at least ┌log₂ Q′┐ bits, where Q′=max {Q1, Q2}. For example, it is assumed that set #A1 is configured as {+1, 0} and set #A2 is configured as {−1, −2}, whereby a single bit may be sufficient to indicate a specific value from set #A1 or set #A2. The above understanding on the size of the MCS adjustment information can avoid any misunderstanding between a BS and a UE on the MCS adjustment information.

The MCS adjustment information may be determined based on whether the current MCS index (e.g., corresponding to the MCS for transmitting the PDSCH as indicated in the DCI format) is underestimated, appropriate, or overestimated.

In some examples, the UE may correctly decode the PDSCH (e.g., the TB). In the case that the current MCS index is underestimated or conservative, the MCS adjustment information may indicate a positive MCS offset value from set #A1. For example, the UE may measure that the current interference level is lower than the last CSI reporting, and may determine that the current MCS index is underestimated. The UE may thus determine that an MCS index higher than the current MCS index can be used in a subsequent (re)transmission. The BS may use a higher MCS index for a subsequent (re)transmission. In the case that the current MCS index is appropriate, the MCS adjustment information may indicate no change (e.g., an MCS offset value of “0” from set #A1). For example, the UE may measure that the current interference level is not changed compared to the last CSI reporting, and may determine that the current MCS index is appropriate. The UE may thus determine that an MCS index equal to the current MCS index can be used in a subsequent (re)transmission. The BS may use the same MCS index for a subsequent (re)transmission. In the case that the current MCS index is overestimated or aggressive, the MCS adjustment information may indicate a negative MCS offset value from set #A1. For example, the UE may measure that the current interference level is higher than the last CSI reporting, and may determine that the current MCS index is overestimated. The UE may thus determine that an MCS index lower than the current MCS index can be used in a subsequent (re)transmission. The BS may use a lower MCS index for a subsequent (re)transmission.

In some examples, the UE may not correctly decode the PDSCH (e.g., the TB). In the case that the current MCS index is underestimated or conservative, the MCS adjustment information may indicate a positive MCS offset value from set #A2. For example, the UE may measure that the current interference level is lower than the last CSI reporting, and may determine that the current MCS index is underestimated. The UE may thus determine that an MCS index higher than the current MCS index can be used in a subsequent (re)transmission. The BS may use a higher MCS index for a subsequent (re)transmission. In the case that the current MCS index is appropriate, the MCS adjustment information may indicate no change (e.g., an MCS offset value of “0” from set #A2). For example, the UE may measure that the current interference level is not changed compared to the last CSI reporting, and may determine that the current MCS index is appropriate. The UE may thus determine that an MCS index equal to the current MCS index can be used in a subsequent (re)transmission. The BS may use the same MCS index for a subsequent (re)transmission. In the case that the current MCS index is overestimated or aggressive, the MCS adjustment information may indicate a negative MCS offset value from set #A2. For example, the UE may measure that the current interference level is higher than the last CSI reporting, and may determine that the current MCS index is overestimated. The UE may thus determine that an MCS index lower than the current MCS index can be used in a subsequent (re)transmission. The BS may use a lower MCS index for a subsequent (re)transmission.

Assuming that the current MCS index is n3 and the MCS adjustment information is x3, this implies that the UE considers that an MCS with an index of n3+x3 is more appropriate for a subsequent (re)transmission to the UE. At the BS side, in response to the reception of the MCS adjustment information, the BS can adjust the MCS for subsequent (re)transmission to the UE based on the MCS adjustment information.

Although the above embodiments are described with respect to a single TB on a single carrier, it should be noted that these embodiments can be applied to the scenario where the UE receives more than one PDSCH on more than one carrier, each of which carries one corresponding PDSCH of the more than one PDSCHs, and the HARQ-ACK feedback for the more than one PDSCH are to be multiplexed in the same slot. For example, the UE may generate MCS adjustment information for each of the more than one carrier (or more than one PDSCH) according to the above embodiments. The BS can adjust the MCS for a subsequent (re)transmission to the UE on the more than one carrier based on the MCS adjustment information for the more than one carrier. The above embodiments can also be applied to the scenario where the UE receives a plurality of PDSCHs on a plurality of carriers, at least one (denoted as carrier #B3) of which carries two or more PDSCHs of the plurality of PDSCHs. In this scenario, the MCS adjustment information for carrier #B3 may indicate an MCS offset value from set #A1 or set #A2 with respect to a reference MCS index (instead of a current MCS index since there may be two or more MCS indexes corresponding to the two or more PDSCHs), depending on the decoding status of the PDSCH. In some embodiments, the MCS adjustment feedback may additionally include MCS adjustment information for a carrier(s) configured for the UE and not included in the more than one carrier or the plurality of carriers.

In some embodiments of the present disclosure, instead of providing two sets of MCS offset values for indicating an MCS adjustment based on the decoding status of a PDSCH (e.g., a TB carried by the PDSCH), a single set of MCS offset values may be configured by, for example, RRC signaling, or predefined.

A UE may receive a PDSCH on a carrier, and the UE may transmit both HARQ-ACK feedback for the PDSCH (e.g., a TB carried by the PDSCH) and MCS adjustment feedback, which may include MCS adjustment information for the current MCS used for transmitting the PDSCH (e.g., the TB). The HARQ-ACK feedback for the PDSCH may be an ACK or NACK indicating whether the PDSCH is correctly decoded or not. The BS can know the decoding status of the PDSCH based on the HARQ-ACK feedback. The MCS adjustment information may indicate to increase or decrease the current MCS index (e.g., corresponding to the MCS for transmitting the PDSCH as indicated in the DCI format) with an offset value. In some examples, the offset value may be equal to “0” which indicates keeping the current MCS index unchanged.

For example, a set of MCS offset values (denoted as set #A3) for indicating an MCS adjustment can be configured by, for example, RRC signaling, or predefined. The MCS adjustment information may indicate an MCS offset value from set #A3.

The number of bits (denoted as Z5) for indicating an MCS offset value (e.g., by indicating the index of the value) from set #A3 may be based on the number of values in set #A3. For example, assuming that set #A3 may include Q3 values, the size of the MCS adjustment information may be based on Q3. For example, Z5=at least ┌log₂ Q3┐ bits. For example, it is assumed that set #A3 is configured as {+1, 0, −1, −2}, whereby two bits may be sufficient to indicate a specific value from set #A3.

The MCS adjustment information may be determined based on whether the current MCS index (e.g., corresponding to the MCS for transmitting the PDSCH as indicated in the DCI format) is underestimated, appropriate, or overestimated.

For example, in the case that the current MCS index is underestimated or conservative, the MCS adjustment information may indicate a positive MCS offset value from set #A3. For example, the UE may measure that the current interference level is lower than the last CSI reporting, and may determine that the current MCS index is underestimated. The UE may thus determine that an MCS index higher than the current MCS index can be used in a subsequent (re)transmission. The BS may use a higher MCS index for subsequent (re)transmission. In the case that the current MCS index is appropriate, the MCS adjustment information may indicate no change (e.g., an MCS offset value of “0” from set #A3). For example, the UE may measure that the current interference level is not changed compared to the last CSI reporting, and may determine that the current MCS index is appropriate. The UE may thus determine that an MCS index equal to the current MCS index can be used in a subsequent (re)transmission. The BS may use the same MCS index for subsequent (re)transmission. In the case that the current MCS index is overestimated or aggressive, the MCS adjustment information may indicate a negative MCS offset value from set #A3. For example, the UE may measure that the current interference level is higher than the last CSI reporting, and may determine that the current MCS index is overestimated. The UE may thus determine that an MCS index lower than the current MCS index can be used in a subsequent (re)transmission. The BS may use a lower MCS index for subsequent (re)transmission.

Assuming that the current MCS index is n4 and the MCS adjustment information is x4, this implies that the UE considers that an MCS with an index of n4+x4 is more appropriate for a subsequent (re)transmission to the UE. At the BS side, in response to the reception of the MCS adjustment information, the BS can adjust the MCS for subsequent (re)transmission to the UE based on the MCS adjustment information.

Although the above embodiments are described with respect to a single TB on a single carrier, it should be noted that these embodiments can be applied to the scenario where the UE receives more than one PDSCH on more than one carrier, each of which carries one corresponding PDSCH of the more than one PDSCHs, and the HARQ-ACK feedback for the more than one PDSCH are to be multiplexed in the same slot. The UE may generate MCS adjustment information for each of the more than one carrier (or more than one PDSCH) according to the above embodiments. The BS can adjust the MCS for a subsequent (re)transmission to the UE on the more than one carrier based on the MCS adjustment information for the more than one carrier. In some embodiments, the MCS adjustment feedback may additionally include MCS adjustment information for a carrier(s) configured for the UE and not included in the more than one carrier.

In some embodiments of the present disclosure, a UE may receive a PDSCH on a carrier, and the UE may transmit only MCS adjustment feedback for the current MCS used for transmitting the PDSCH (e.g., a TB carried by the PDSCH). The HARQ-ACK feedback for the PDSCH (e.g., the TB) can be implicitly indicated by the MCS adjustment feedback. The current MCS for transmitting the PDSCH may be indicated in the DCI format scheduling the PDSCH.

MCS adjustment feedback may include MCS adjustment information, which may indicate to increase or decrease the current MCS index (e.g., corresponding to the MCS for transmitting the PDSCH as indicated in the DCI format) with an offset value. In some examples, the offset value may be equal to “0” which indicates keeping the current MCS index unchanged. In some examples, increasing the current MCS index may imply that the UE has correctly decoded the PDSCH (e.g., the TB), and decreasing the current MCS index may imply that the UE fails to decoded the PDSCH (e.g., the TB). In some examples, maintaining the current MCS index may imply that the UE has correctly decoded the PDSCH (e.g., the TB).

In some embodiments, a set of MCS offset values (denoted as set #A4) for indicating an MCS adjustment can be configured by, for example, RRC signaling, or predefined. The MCS adjustment information may indicate an MCS offset value from set #A4.

The number of bits (denoted as Z6) for indicating an MCS offset value (e.g., by indicating the index of the value) from set #A4 may be based on the number of values in set #A4. For example, assuming that set #A4 may include Q4 values, the size of the MCS adjustment information may be based on Q4. For example, Z6=at least ┌log₂ Q4┐ bits. For example, it is assumed that set #A4 is configured as {+1, 0, −1, −2}, two bits may be sufficient to indicate a specific value from set #A4.

The MCS adjustment information may be determined based on whether the current MCS index (e.g., corresponding to the MCS for transmitting the PDSCH as indicated in the DCI format) is underestimated, appropriate, or overestimated.

In some examples, the UE may correctly decode the PDSCH (e.g., the TB) and determine that the current MCS index is underestimated or conservative, the MCS adjustment information may indicate a positive MCS offset value from set #A4. For example, the UE may measure that the current interference level is lower than the last CSI reporting, and may determine that the current MCS index is underestimated. The UE may thus determine that an MCS index higher than the current MCS index can be used in a subsequent (re)transmission. The BS may use a higher MCS index for a subsequent (re)transmission to the UE. To put it another way, a positive MCS offset value may suggest that the UE has correctly decoded the PDSCH (e.g., corresponding to an ACK feedback for the PDSCH) and a higher MCS can be used for the subsequent (re)transmission to the UE.

In some examples, the UE may correctly decode the PDSCH (e.g., the TB) and determine that the current MCS index is appropriate, the MCS adjustment information may indicate no change (e.g., an MCS offset value of “0” from set #A4). For example, the UE may measure that the current interference level is not changed compared to the last CSI reporting, and may determine that the current MCS index is appropriate. The UE may thus determine that an MCS index equal to the current MCS index can be used in a subsequent (re)transmission. The BS may use the same MCS index for a subsequent (re)transmission to the UE. To put it another way, an MCS offset value of “0” may suggest that the UE has correctly decoded the PDSCH (e.g., corresponding to an ACK feedback for the PDSCH) and the same MCS can be used for the subsequent (re)transmission to the UE.

In some examples, the UE may fail to decode the PDSCH (e.g., the TB) and determine that the current MCS index is overestimated or aggressive, the MCS adjustment information may indicate a negative MCS offset value from set #A4. For example, the UE may measure that the current interference level is lower than the last CSI reporting, and may determine that the current MCS index is underestimated. The UE may thus determine that an MCS index lower than the current MCS index can be used in a subsequent (re)transmission. The BS may use a lower MCS index for a subsequent (re)transmission to the UE. To put it another way, a negative MCS offset value may suggest that the UE fails to decoded the PDSCH (e.g., corresponding to a NACK feedback for the PDSCH) and a lower MCS can be used for the subsequent (re)transmission to the UE.

Assuming that the current MCS index is n4 and the MCS adjustment information is x4, this implies that the UE considers that an MCS with an index of n4+x4 is more appropriate for a subsequent (re)transmission to the UE. At the BS side, in response to the reception of the MCS adjustment information, the BS can adjust the MCS for a subsequent (re)transmission to the UE based on the MCS adjustment information.

Although the above embodiments are described with respect to a single TB on a single carrier, it should be noted that these embodiments can be applied to the scenario where the UE receives more than one PDSCH on more than one carrier, each of which carries one corresponding PDSCH of the more than one PDSCHs, and the HARQ-ACK feedback for the more than one PDSCH are to be multiplexed in the same slot. The UE may generate MCS adjustment information for each of the more than one carrier (or more than one PDSCH) according to the above embodiments. The BS can determine the HARQ-ACK feedback for the more than one PDSCH and adjust the MCS for a subsequent (re)transmission to the UE on the more than one carrier based on the MCS adjustment information for the more than one carrier. In some embodiments, the MCS adjustment feedback may additionally include MCS adjustment information for a carrier(s) configured for the UE and not included in the more than one carrier.

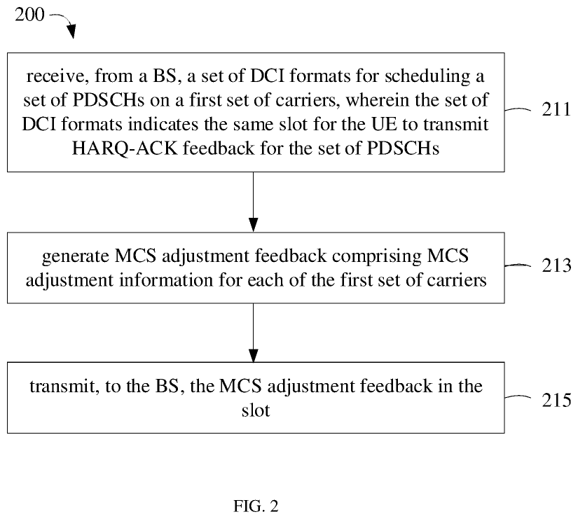

FIG. 2 illustrates a flow chart of an exemplary procedure 200 for wireless communications in accordance with some embodiments of the present disclosure. Details described in all of the foregoing embodiments of the present disclosure are applicable for the embodiments shown in FIG. 2. In some examples, the procedure may be performed by a UE, for example, UE 101 in FIG. 1.

Referring to FIG. 2, in operation 211, a UE may receive, from a BS, a set of DCI formats for scheduling a set of PDSCHs on a first set of carriers, wherein the set of DCI formats indicates the same slot for the UE to transmit HARQ-ACK feedback for the set of PDSCHs.

In operation 213, the UE may generate MCS adjustment feedback comprising MCS adjustment information for each of the first set of carriers. In operation 215, the UE may transmit, to the BS, the MCS adjustment feedback in the slot.

In some embodiments of the present disclosure, the MCS adjustment information for each of the first set of carriers are ordered in the MCS adjustment feedback according to serving cell indexes associated with the first set of carriers.

In some embodiments of the present disclosure, the MCS adjustment information for each of the first set of carriers indicates an MCS offset value from a set of MCS offset values for a corresponding carrier with respect to a reference MCS index for the corresponding carrier. In some embodiments, the MCS adjustment information for the corresponding carrier indicates a positive MCS offset value from the set of MCS offset values in the case that the UE suggests using an MCS index higher than the reference MCS index for the corresponding carrier in a subsequent (re)transmission. In some embodiments, the MCS adjustment information for the corresponding carrier indicates no change to the reference MCS index from the set of MCS offset values in the case that the UE suggests using an MCS index equal to the reference MCS index for the corresponding carrier in a subsequent (re)transmission. In some embodiments, the MCS adjustment information for the corresponding carrier indicates a negative MCS offset value from the set of MCS offset values in the case that the UE suggests using an MCS index lower than the reference MCS index for the corresponding carrier in a subsequent (re)transmission.

In some embodiments of the present disclosure, a size of the MCS adjustment feedback is based on a number of carriers within the first set of carriers and a number of values in a set of MCS offset values for each of the first set of carriers.

In some embodiments of the present disclosure, a size of the MCS adjustment feedback is based on a total number of carriers configured for the UE and a number of values in a set of MCS offset values for each of the configured carriers. In some embodiments, the MCS adjustment information for a second carrier configured to the UE and not included in the first set of carriers comprises a padding bit(s). In some embodiments, the MCS adjustment information for the second carrier is with respect to a reference MCS index of a reference carrier. In some embodiments of the present disclosure, the reference carrier is a carrier within the first set of carriers nearest to the second carrier in a frequency domain. In some embodiments of the present disclosure, the reference carrier is a carrier with the lowest or highest serving cell index within the first set of carriers.

In some embodiments of the present disclosure, for each of the first set of carriers, the reference MCS index indicates an MCS of a specific (e.g., earliest or last) PDSCH of at least one PDSCH of the set of PDSCHs, wherein the at least one PDSCH is received on a corresponding carrier of the first set of carriers. In some embodiments of the present disclosure, for each of the first set of carriers, the reference MCS index indicates an average MCS of the at least one PDSCH received on the corresponding carrier.

In some embodiments of the present disclosure, the MCS adjustment information for each carrier of the first set of carriers indicates a first MCS offset value from a first set of MCS offset values for a corresponding carrier in the case that a PDSCH of the set of PDSCHs received on the corresponding carrier is correctly decoded by the UE. In some embodiments of the present disclosure, the MCS adjustment information for each carrier of the first set of carriers indicates a second MCS offset value from a second set of MCS offset values for the corresponding carrier in the case that the PDSCH received on the corresponding carrier is incorrectly decoded by the UE. In some embodiments of the present disclosure, the number of values in the first set of MCS offset values is the same as that in the second set of MCS offset values. In some embodiments of the present disclosure, a size of the MCS adjustment information for the corresponding carrier is based on a larger set of the first set of MCS offset values and the second set of MCS offset values.

In some embodiments of the present disclosure, the MCS adjustment information for each carrier of the first set of carriers indicates a first MCS offset value from a first set of MCS offset values for a corresponding carrier. In some embodiments of the present disclosure, a size of the MCS adjustment information for the corresponding carrier is based on a number of values in the first set of MCS offset values for the corresponding carrier.

In some embodiments of the present disclosure, the UE may transmit the HARQ-ACK feedback for the set of PDSCHs along with the MCS adjustment feedback in the slot.

In some embodiments of the present disclosure, for a first PDSCH of the set of PDSCHs received on a first carrier of the first set of carriers, the HARQ-ACK feedback for the first PDSCH is not transmitted in the slot. In some embodiments of the present disclosure, the MCS adjustment information for the first carrier indicates a positive MCS offset value in the case that the UE correctly decodes the first PDSCH and suggests using an MCS index higher than an MCS of the first PDSCH in a subsequent (re)transmission. In some embodiments of the present disclosure, the MCS adjustment information for the first carrier indicates no change to the MCS of the first PDSCH in the case that the UE correctly decodes the first PDSCH and suggests using an MCS index equal to the MCS of the first PDSCH in a subsequent (re)transmission. In some embodiments of the present disclosure, the MCS adjustment information for the first carrier indicates a negative MCS offset value in the case that the UE incorrectly decodes the first PDSCH and suggests using an MCS index lower than the MCS of the first PDSCH in a subsequent (re)transmission.

It should be appreciated by persons skilled in the art that the sequence of the operations in exemplary procedure 200 may be changed and some of the operations in exemplary procedure 200 may be eliminated or modified, without departing from the spirit and scope of the disclosure.

FIG. 3 illustrates a flow chart of an exemplary procedure 300 for wireless communications in accordance with some embodiments of the present disclosure. Details described in all of the foregoing embodiments of the present disclosure are applicable for the embodiments shown in FIG. 3. In some examples, the procedure may be performed by a BS, for example, BS 102 in FIG. 1.

Referring to FIG. 3, in operation 311, a BS may transmit, to a UE, a set of DCI formats for scheduling a set of PDSCHs on a first set of carriers, wherein the set of DCI formats indicates a same slot for the UE to transmit HARQ-ACK feedback for the set of PDSCHs. In operation 313, the BS may receive, from the UE, MCS adjustment feedback in the slot, wherein the MCS adjustment feedback comprises MCS adjustment information for each of the first set of carriers.

In some embodiments of the present disclosure, the MCS adjustment information for each of the first set of carriers are ordered in the MCS adjustment feedback according to serving cell indexes associated with the first set of carriers.

In some embodiments of the present disclosure, the MCS adjustment information for each of the first set of carriers indicates an MCS offset value from a set of MCS offset values for a corresponding carrier with respect to a reference MCS index for the corresponding carrier. In some embodiments of the present disclosure, the MCS adjustment information for the corresponding carrier indicates a positive MCS offset value from the set of MCS offset values in the case that the UE suggests using an MCS index higher than the reference MCS index for the corresponding carrier in a subsequent (re)transmission. In some embodiments of the present disclosure, the MCS adjustment information for the corresponding carrier indicates no change to the reference MCS index from the set of MCS offset values in the case that the UE suggests using an MCS index equal to the reference MCS index for the corresponding carrier in a subsequent (re)transmission. In some embodiments of the present disclosure, the MCS adjustment information for the corresponding carrier indicates a negative MCS offset value from the set of MCS offset values in the case that the UE suggests using an MCS index lower than the reference MCS index for the corresponding carrier in a subsequent (re)transmission.

In some embodiments of the present disclosure, a size of the MCS adjustment feedback is based on a number of carriers within the first set of carriers and a number of values in a set of MCS offset values for each of the first set of carriers.

In some embodiments of the present disclosure, a size of the MCS adjustment feedback is based on a total number of carriers configured for the UE and a number of values in a set of MCS offset values for each of the configured carriers. In some embodiments of the present disclosure, the MCS adjustment information for a second carrier configured to the UE and not included in the first set of carriers comprises a padding bit(s). In some embodiments of the present disclosure, the MCS adjustment information for the second carrier is with respect to a reference MCS index of a reference carrier. In some embodiments of the present disclosure, the reference carrier is a carrier within the first set of carriers nearest to the second carrier in a frequency domain. In some embodiments of the present disclosure, the reference carrier is a carrier with the lowest or highest serving cell index within the first set of carriers.

In some embodiments of the present disclosure, for each of the first set of carriers, the reference MCS index indicates an MCS of a specific PDSCH of at least one PDSCH of the set of PDSCHs. The at least one PDSCH is transmitted on a corresponding carrier of the first set of carriers. In some embodiments of the present disclosure, for each of the first set of carriers, the reference MCS index indicates an average MCS of the at least one PDSCH transmitted on the corresponding carrier.

In some embodiments of the present disclosure, the MCS adjustment information for each carrier of the first set of carriers indicates a first MCS offset value from a first set of MCS offset values for a corresponding carrier in the case that a PDSCH of the set of PDSCHs transmitted on the corresponding carrier is correctly decoded by the UE. In some embodiments of the present disclosure, the MCS adjustment information for each carrier of the first set of carriers indicates a second MCS offset value from a second set of MCS offset values for the corresponding carrier in the case that the PDSCH transmitted on the corresponding carrier is incorrectly decoded by the UE. In some embodiments of the present disclosure, the number of values in the first set of MCS offset values is the same as that in the second set of MCS offset values. In some embodiments of the present disclosure, a size of the MCS adjustment information for the corresponding carrier is based on a larger set of the first set of MCS offset values and the second set of MCS offset values.

In some embodiments of the present disclosure, the MCS adjustment information for each carrier of the first set of carriers indicates a first MCS offset value from a first set of MCS offset values for a corresponding carrier. In some embodiments of the present disclosure, a size of the MCS adjustment information for the corresponding carrier is based on a number of values in the first set of MCS offset values for the corresponding carrier.

In some embodiments of the present disclosure, the BS may receive the HARQ-ACK feedback for the set of PDSCHs along with the MCS adjustment feedback in the slot.

In some embodiments of the present disclosure, for a first PDSCH of the set of PDSCHs transmitted on a first carrier of the first set of carriers, the HARQ-ACK feedback for the first PDSCH is not received in the slot. In some embodiments of the present disclosure, the MCS adjustment information for the first carrier indicates a positive MCS offset value in the case that the UE correctly decodes the first PDSCH and suggests using an MCS index higher than an MCS of the first PDSCH in a subsequent (re)transmission. In some embodiments of the present disclosure, the MCS adjustment information for the first carrier indicates no change to the MCS of the first PDSCH in the case that the UE correctly decodes the first PDSCH and suggests using an MCS index equal to the MCS of the first PDSCH in a subsequent (re)transmission. In some embodiments of the present disclosure, the MCS adjustment information for the first carrier indicates a negative MCS offset value in the case that the UE incorrectly decodes the first PDSCH and suggests using an MCS index lower than the MCS of the first PDSCH in a subsequent (re)transmission.

In some embodiments of the present disclosure, the BS may adjust an MCS of a subsequent transmission to the UE on the first set of carriers based on the MCS adjustment feedback.

It should be appreciated by persons skilled in the art that the sequence of the operations in exemplary procedure 300 may be changed and some of the operations in exemplary procedure 300 may be eliminated or modified, without departing from the spirit and scope of the disclosure.

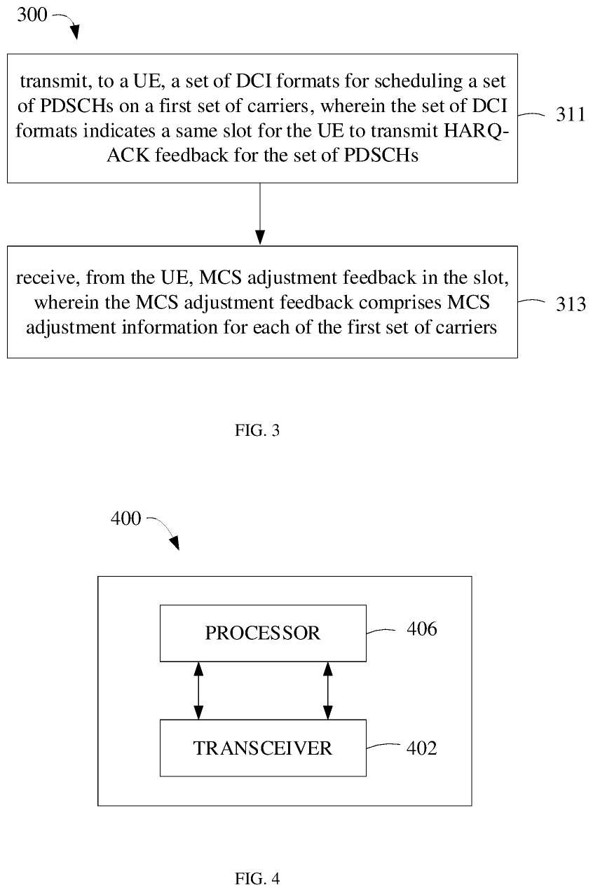

FIG. 4 illustrates a block diagram of an exemplary apparatus 400 according to some embodiments of the present disclosure. As shown in FIG. 4, the apparatus 400 may include at least one processor 406 and at least one transceiver 402 coupled to the processor 406. The apparatus 400 may be a UE or a BS.

Although in this figure, elements such as the at least one transceiver 402 and processor 406 are described in the singular, the plural is contemplated unless a limitation to the singular is explicitly stated. In some embodiments of the present application, the transceiver 402 may be divided into two devices, such as a receiving circuitry and a transmitting circuitry. In some embodiments of the present application, the apparatus 400 may further include an input device, a memory, and/or other components.

In some embodiments of the present application, the apparatus 400 may be a UE. The transceiver 402 and the processor 406 may interact with each other so as to perform the operations with respect to the UE described in FIGS. 1-3. In some embodiments of the present application, the apparatus 400 may be a BS. The transceiver 402 and the processor 406 may interact with each other so as to perform the operations with respect to the BS described in FIGS. 1-3.

In some embodiments of the present application, the apparatus 400 may further include at least one non-transitory computer-readable medium.

For example, in some embodiments of the present disclosure, the non-transitory computer-readable medium may have stored thereon computer-executable instructions to cause the processor 406 to implement the method with respect to the UE as described above. For example, the computer-executable instructions, when executed, cause the processor 406 interacting with transceiver 402 to perform the operations with respect to the UE described in FIGS. 1-3.

In some embodiments of the present disclosure, the non-transitory computer-readable medium may have stored thereon computer-executable instructions to cause the processor 406 to implement the method with respect to the BS as described above. For example, the computer-executable instructions, when executed, cause the processor 406 interacting with transceiver 402 to perform the operations with respect to the BS described in FIGS. 1-3.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A user equipment (UE), comprising:
at least one memory; and
at least one processor coupled with the at least one memory and configured to cause the UE to:
receive, from a base station, a set of downlink control information (DCI) formats for scheduling a set of physical downlink shared channels (PDSCHs) on a first set of carriers, wherein the set of DCI formats indicates the same slot for the UE to transmit hybrid automatic repeat request acknowledgement (HARQ-ACK) feedback for the set of PDSCHs;
generate modulation and coding scheme (MCS) adjustment feedback comprising MCS adjustment information for each of the first set of carriers; and
transmit, to the base station, the MCS adjustment feedback in the slot.

2. The UE of claim 1, wherein the MCS adjustment information for each of the first set of carriers are ordered in the MCS adjustment feedback according to serving cell indexes associated with the first set of carriers.

3. The UE of claim 1, wherein the MCS adjustment information for each of the first set of carriers indicates an MCS offset value from a set of MCS offset values for a corresponding carrier with respect to a reference MCS index for the corresponding carrier.

4. The UE of claim 3, wherein the MCS adjustment information for the corresponding carrier indicates a positive MCS offset value from the set of MCS offset values in response to the UE suggests using an MCS index higher than the reference MCS index for the corresponding carrier in a subsequent (re)transmission;
wherein the MCS adjustment information for the corresponding carrier indicates no change to the reference MCS index from the set of MCS offset values in response to the UE suggests using an MCS index equal to the reference MCS index for the corresponding carrier in a subsequent (re)transmission; or
wherein the MCS adjustment information for the corresponding carrier indicates a negative MCS offset value from the set of MCS offset values in response to the UE suggests using an MCS index lower than the reference MCS index for the corresponding carrier in a subsequent (re)transmission.

5. The UE of claim 1, wherein a size of the MCS adjustment feedback is based on a number of carriers within the first set of carriers and a number of values in a set of MCS offset values for each of the first set of carriers.

6. The UE of claim 1, wherein a size of the MCS adjustment feedback is based on a total number of carriers configured for the UE and a number of values in a set of MCS offset values for each of the configured carriers;
wherein the MCS adjustment information for a second carrier configured to the UE and not included in the first set of carriers comprises a padding bit(s), or is with respect to a reference MCS index of a reference carrier.

7. The UE of claim 6, wherein the reference carrier is a carrier within the first set of carriers nearest to the second carrier in a frequency domain;
wherein the reference carrier is a carrier within the first set of carriers having a serving cell index closest to that of the second carrier; or
wherein the reference carrier is a carrier with the lowest or highest serving cell index within the first set of carriers.

8. The UE of claim 7, wherein for each of the first set of carriers, the reference MCS index indicates:
an MCS of a specific PDSCH of at least one PDSCH of the set of PDSCHs, wherein the at least one PDSCH is received on a corresponding carrier of the first set of carriers; or
an average MCS of the at least one PDSCH received on the corresponding carrier.

9. The UE of claim 1, wherein the MCS adjustment information for each carrier of the first set of carriers indicates a first MCS offset value from a first set of MCS offset values for a corresponding carrier in response to a PDSCH of the set of PDSCHs received on the corresponding carrier is correctly decoded by the UE, or indicates a second MCS offset value from a second set of MCS offset values for the corresponding carrier in response to the PDSCH received on the corresponding carrier is incorrectly decoded by the UE.

10. The UE of claim 1, wherein the MCS adjustment information for each carrier of the first set of carriers indicates a first MCS offset value from a first set of MCS offset values for a corresponding carrier.

11. The UE of claim 12, wherein a size of the MCS adjustment information for the corresponding carrier is based on a number of values in the first set of MCS offset values for the corresponding carrier.

12. The UE of claim 1, wherein the at least one processor is configured to cause the UE to transmit the HARQ-ACK feedback for the set of PDSCHs along with the MCS adjustment feedback in the slot.

13. The UE of claim 1, wherein for a first PDSCH of the set of PDSCHs received on a first carrier of the first set of carriers,
the MCS adjustment information for the first carrier indicates a positive MCS offset value in response to the UE correctly decoding the first PDSCH and suggests using an MCS index higher than an MCS of the first PDSCH in a subsequent (re)transmission;
the MCS adjustment information for the first carrier indicates no change to the MCS of the first PDSCH in response to the UE correctly decoding the first PDSCH and suggests using an MCS index equal to the MCS of the first PDSCH in a subsequent (re)transmission; or
the MCS adjustment information for the first carrier indicates a negative MCS offset value in response to the UE incorrectly decoding the first PDSCH and suggests using an MCS index lower than the MCS of the first PDSCH in a subsequent (re)transmission.

14. A base station, comprising:
a transceiver; and
a processor coupled to the transceiver, wherein the processor is configured to:
at least one memory; and
at least one processor coupled with the at least one memory and configured to cause the base station to:
transmit, to a user equipment (UE), a set of downlink control information (DCI) formats for scheduling a set of physical downlink shared channels (PDSCHs) on a first set of carriers, wherein the set of DCI formats indicates a same slot for the UE to transmit hybrid automatic repeat request acknowledgement (HARQ-ACK) feedback for the set of PDSCHs; and
receive, from the UE, modulation and coding scheme (MCS) adjustment feedback in the slot, wherein the MCS adjustment feedback comprises MCS adjustment information for each of the first set of carriers.

15. A method performed by a user equipment (UE), the method comprising:
receiving, from a base station, a set of downlink control information (DCI) formats for scheduling a set of physical downlink shared channels (PDSCHs) on a first set of carriers, wherein the set of DCI formats indicates the same slot for the UE to transmit hybrid automatic repeat request acknowledgement (HARQ-ACK) feedback for the set of PDSCHs;
generating modulation and coding scheme (MCS) adjustment feedback comprising MCS adjustment information for each of the first set of carriers; and
transmitting, to the base station, the MCS adjustment feedback in the slot.

16. The method of claim 15, wherein the MCS adjustment information for each of the first set of carriers are ordered in the MCS adjustment feedback according to serving cell indexes associated with the first set of carriers.

17. The method of claim 15, wherein the MCS adjustment information for each of the first set of carriers indicates an MCS offset value from a set of MCS offset values for a corresponding carrier with respect to a reference MCS index for the corresponding carrier.

18. The method of claim 17, wherein the MCS adjustment information for the corresponding carrier indicates a positive MCS offset value from the set of MCS offset values in response to the UE suggests using an MCS index higher than the reference MCS index for the corresponding carrier in a subsequent (re)transmission;
wherein the MCS adjustment information for the corresponding carrier indicates no change to the reference MCS index from the set of MCS offset values in response to the UE suggests using an MCS index equal to the reference MCS index for the corresponding carrier in a subsequent (re)transmission; or
wherein the MCS adjustment information for the corresponding carrier indicates a negative MCS offset value from the set of MCS offset values in response to the UE suggests using an MCS index lower than the reference MCS index for the corresponding carrier in a subsequent (re)transmission.

19. The method of claim 15, wherein a size of the MCS adjustment feedback is based on a number of carriers within the first set of carriers and a number of values in a set of MCS offset values for each of the first set of carriers.

20. A method performed by a base station, the method comprising:
transmitting, to a user equipment (UE), a set of downlink control information (DCI) formats for scheduling a set of physical downlink shared channels (PDSCHs) on a first set of carriers, wherein the set of DCI formats indicates a same slot for the UE to transmit hybrid automatic repeat request acknowledgement (HARQ-ACK) feedback for the set of PDSCHs; and
receiving, from the UE, modulation and coding scheme (MCS) adjustment feedback in the slot, wherein the MCS adjustment feedback comprises MCS adjustment information for each of the first set of carriers.
